(19) United States
(12) Patent Application Publication
(10) Pub. No.: US 2025/0376808 A1
(43) Pub. Date: Dec. 11, 2025

(54) BIODEGRADABLE BARRIER COATING

(71) Applicant: Terram Technologies, Inc., Scottsdale, AZ (US)

(72) Inventors: Ashley Sue Thompson, Hoover, AL (US); John G. Brown, Vestavia Hills, CA (US); Clay C. Knight, Tuscaloosa, AL (US); Heather Malone Watson, Northport, AL (US)

(21) Appl. No.: 19/189,463

(22) Filed: Apr. 25, 2025

Related U.S. Application Data
(60) Provisional application No. 63/656,282, filed on Jun. 5, 2024.

(51) Int. Cl. D21H 19/12; C08K 3/16; C08L 1/02; D21H 25/04; D21H 27/10

(52) U.S. Cl. CPC D21H 19/12; C08K 3/16; C08L 1/02; D21H 25/04; D21H 27/10; C08K 2003/162

(57) ABSTRACT

Described herein is a formulation that may be applied on various substrates (paper/molded fiber/containerboard/corrugated/poly), which gives those materials an unsurpassed OGR, OTR, and release properties at extremely low coat weights.

### REFERENCE TO RELATED APPLICATION

The present application claims priority to U.S. Provisional Patent Application Ser. No. 63/656,282, entitled BIODEGRADABLE OIL AND GREASE BARRIER, filed Jun. 5, 2024, the entire contents of which are hereby incorporated by reference.

### TECHNICAL FIELD

The subject matter disclosed herein is generally directed to a barrier coating formulation that may be applied to a variety of permeable substrates used in the food packaging industry, and which imparts multi-functional barrier coatings to those materials at extremely low coat weights.

### BACKGROUND

With the phasing out of per- and polyfluoroalkyl/perfluorooctane sulfonate (PFAS/PFOS) substances, there exists a major need in the market for biodegradable oil and grease barriers, oxygen vapor barriers, along with other properties that are desirable in the food service, food packaging and paper industries. Accordingly, it is an object of the present disclosure to provide a biodegradable and environmentally sustainable barrier material, providing a low oxygen transmission rate (OTR), oil and grease resistance (OGR) and effective release properties.

Citation or identification of any document in this application is not an admission that such a document is available as prior art to the present disclosure.

### SUMMARY

The above objectives are accomplished according to the present disclosure by providing a formulation that can be applied on typical sustainable packaging substrates (paper/molded fiber/containerboard/corrugated/poly) and which gives those materials a desirable OGR, OTR, and release properties at extremely low coat weights as described and shown herein.

The current disclosure further provides methods for making a formulation that can be applied on paper/molded fiber/containerboard/corrugated/poly, which gives those materials heretofore unknown OGR, OTR and Release properties at extremely low coat weights as described and shown herein.

These and other aspects, objects, features, and advantages of the example embodiments will become apparent to those having ordinary skill in the art upon consideration of the following detailed description of example embodiments.

### DRAWING FIGURES

The invention will now be described in conjunction with the appended drawing figures, wherein like numbers denote like elements and:

FIG. 1 is a flow chart illustrating an exemplary method of making a coated substrate in accordance with the present invention.

### DETAILED DESCRIPTION OF THE EXAMPLE EMBODIMENTS

Before the present disclosure is described in greater detail, it is to be understood that this disclosure is not limited to particular embodiments described. It is also to be understood that the terminology used herein is for the purpose of describing particular embodiments only and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such 99 6 as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. “about x, y, z, or less” and should be interpreted to include the specific ranges of “about x”, “about y”, and “about z” as well as the ranges of “less than x”, “less than y”, and “less than z”. Likewise, the phrase “about x, y, z, or greater” should be interpreted to include the specific ranges of “about x”, “about y”, and “about z” as well as the ranges of “greater than x”, “greater than y”, and “greater than z”. In addition, the phrase “about ‘x’ to ‘y’, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or subranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g. mass, volume, dosage, concentration, and/or time period) needed to achieve one or more desired and/or stated result(s). For example, a functionally effective amount refers to an amount needed to achieve one or more functional effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values of the specified components in the disclosed composition or formulation are equal to 100.

As used herein, “water-soluble”, as used herein, generally means at least about 10 g of a substance is soluble in 1 L of water, i.e., at neutral pH, at 25° C.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

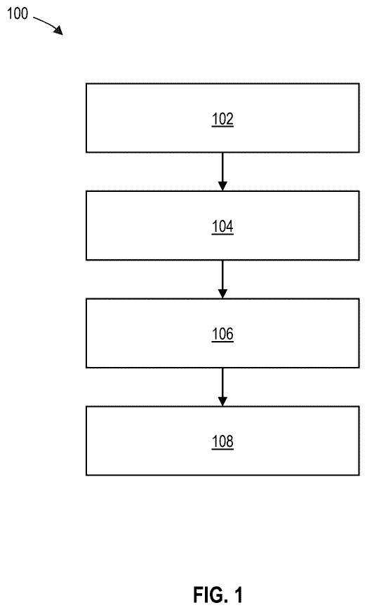

Referring now to FIG. 1, an exemplary method 100 for fabricating coated substrates in accordance with the present disclosure includes the steps of: i) providing a liquid coating formulation 102; ii) applying the liquid coating formulation to a food packaging substrate 104; iii) drying the coated substrate 106; and wrapping the prepared food with the dried coated substrate 108.

### Kit Tests

In order to quantify oil and grease resistance, KIT Test Method (TAPPI T559) or variations thereof may be employed. Standard KTI tests follow the TAPPI T559 cm-02 standard, which specifies how to apply a series of oils with increasing solvency power onto a coated surface to determine its resistance level.

### Preparation of Test Surface:

a. A sample of the coated paper, board, or film is cut to size;
b. The sample is placed on a flat, non-absorbent surface.

### Application of KIT Test Solutions:

a. A series of twelve standard oil mixtures (ranging from low to high penetration ability) are applied in small drops on the surface;
b. Each solution contains different ratios of castor oil, toluene, heptane, and other solvents with increasing solvency power;
c. The solutions are ranked from KIT Level 1 (least aggressive) to KIT Level 12 (most aggressive).

### Observation Period:

a. The oil mixtures are left on the surface for 15 seconds to 15 minutes, depending on the test setup;
b. After the waiting period, the excess oil is removed using absorbent paper.

### Evaluation:

a. The highest-numbered solution that does not penetrate, stain, or discolor the coating determines the KIT rating;
b. If no penetration occurs at KIT Level 12, the coating is considered highly oil-resistant;
c. If penetration occurs at a lower level (e.g., KIT Level 5), the coating has moderate oil resistance.

### KIT Rating Scale:

a. KIT 1-3: Low oil/grease resistance (poor barrier);
b. KIT 4-6: Moderate oil/grease resistance;
c. KIT 7-9: High oil/grease resistance;
d. KIT 10-12: Excellent oil/grease resistance (strong barrier, suitable for food packaging and high-fat content applications).

### Factors Affecting KIT Ratings:

a. Several factors influence the oil and grease resistance of coatings.

### Coating Composition:

a. Fluorochemical coatings: Higher KIT levels (strong barrier properties);
b. Wax coatings: Moderate resistance;
c. Clay or starch-based coatings: Lower resistance.

### Coating Thickness:

a. Thicker coatings generally offer better resistance.

### Curing Process:

a. Proper drying and curing improve barrier performance.

### Surface Treatment:

a. Additional treatments like calendaring or lamination can enhance resistance.

### Applications of KIT Testing:

a. Food Packaging: Evaluates grease resistance in fast food wrappers, pizza boxes, and microwave packaging;
b. Industrial Coatings: Used in oil-resistant coatings for machinery and equipment;
c. Barrier Films: Measures the oil permeability of polymer-coated paper and films.

The KIT test is a simple and effective way to assess oil and grease resistance in coatings. A higher KIT rating indicates better resistance, making it a crucial test for materials used in food packaging, industrial coatings, and barrier applications.

The current disclosure provides formulations that can be applied on paper/molded fiber/containerboard/corrugated/poly which gives those materials a highly desirable OGR at extremely low coat weights. The material is laid down wet and then subjected to a drying process. The removal of water allows the functional groups of the HPMC chains to chelate with the calcium ions, magnesium ions, iron ions, silver ions, zinc ions, mercury ions, and/or any divalent ions, as well as available free side chains of the substrate itself. This chelation occurs with or without a suitable chelation agent. Any material or external charging apparatus capable of imparting a charge to the substrate may be used as well. This prevents immediate rehydration, making it suitable for many applications in the food service industry.

Currently, HPMC (hydroxypropyl methyl cellulose) is used without an adjacent substrate as an encapsulant in the pharmaceutical industry, and in particular is known as an effective barrier/capsule material for nutraceutical oils when used alone (without an underlying substrate). It is easily water soluble, has a known compatibility with a wide variety of encapsulated medicines, and is FDA/BFR approved for human consumption. It is currently unexplored in the food packaging industry, although it has itself been proposed as such over the years, but has not been commercially available due to severe limitations such as fragility, cost, and incompatibilities with typical packaging performance needs. By achieving desirable OGR and OTR values at very low coat weights as described herein, the use of HPMC as a barrier attached to substrates for use in the food packaging industry may now be commercially viable.

The current disclosure uses the HPMC grades known to be food contact/pharma approved (E/F/K grades) and combine with a calcium salt (preferably CaCl₂)) to form a complex wherein certain side chains of HPMC will chelate with calcium and stabilize enough to be resistant to immediate solubilization in water, lending itself to short term food applications (quick serve restaurants, QSR), disposable dishes, cutlery, etc.) while remaining fundamentally unchanged chemically from its biodegradable nature as a polyether and thereby hydrolysis-susceptible polymer chain for purposes of subsequent biodegradation.

E/F/K grades of HPMC relate to degrees and types of substitutions on the cellulose backbone. These are established percentages and common in the pharmaceutical industry. The industry recognizes these designations and is they are standardized globally. Typically, the E/F/K grade is followed by a number such as E5, K15 and F50, which denotes viscosity in centipoise at 2% solution and correlates to molecular weight. Most of the present formulations designed for barriers utilize F50, as it is a suitable mix of chain length (for barrier properties), cost, and viscosity. Viscosity is the key parameter in most coating operations, as engineers must always contend with viscosity and percent solids variables. Most formulations are 8-12% solids, meaning that there is significant water that could deform the substrate, which therefore requires heating to remove the water to be an effective coating.

The present inventors have also established additives within this material that make it more suitable for industrially common coating methods, such as flexographic, gravure, curtain, slot die, rod, blade and similar. Applicant further proposes incorporating antimicrobials or biocidal agents as appropriate for liquid state shelf-life extension. Other functional modifiers include a variety of defoamers, plasticizers, and solvent regimens (such as low molecular weight alcohols in amounts up to 25%, co-solvents such as acetone, etc.) to enhance coating compatibility/efficiency/performance. Many formulations are also capable of being folded while still providing a barrier, even under extreme conditions such as the RP2 test (Ralston Purina test, used for pet food, high temperature, folding, considered “aggressive grease resistance” (AGR)).

Additionally, the present inventors have explored differences between high and low molecular weight HPMCs and their properties. Examples would be selection of certain low molecular weight cellulosics for compatibility with heat seal (thermoplastic) products, or high MW for heat (i.e. thermoset/oven resistance, comparable to PET). Depending on the HPMC chosen and the calcium density/plasticizer(s), it may also be used as a wet adhesive. The current disclosure has also established that with higher crosslink density, there is a very good OTR achieved, adding to its usefulness.

The effective barrier is at a very low (2-7 gsm dry) coat weight when compared to typical plastics used as barrier coatings, since the active functional groups of the HPMC chains and the calcium itself will chelate/bind to the substrate and negate difficulties seen in surface morphology that would make rougher surfaces require an uneconomical coat weight of 17-50 gsm. This gives it an inherent economic advantage in the market.

### General Observations

### Mixing Time

Solutions may be mixed by slowly adding the dry ingredients to tap water under high shear mixing; that is, to adequately disperse the dry powder into the solution and avoid agglomeration. This can be effectively accomplished with an eductor, agitator, and/or recirculating apparatus.

A defoamer may be added to water prior to the addition of dry ingredients for best results. Adding a defoamer after addition of dry ingredients is not optimal as it does not disperse well in high viscosity media.

The coating usually takes 2-4 hours of high shear mixing to go into solution but can be longer for high solids content. The higher the total dissolved solids, the longer the mixing time will be.

Solutions containing entrapped air must be allowed to settle with low or no agitation before use to prevent air bubbles from being applied to substrates. This can also be done with degassing hardware as air entrainment can significantly compromise barrier efficacy. Degassing hardware allows for visible reduction in bubbles or entrained air. Defoaming agents can also be used. Specific defoamers are selected that will not inhibit network formation, biodedegration or regulatory status as food contact safe.

### Shelf Life

In powdered form, the coating is stable as long as it is kept dry. Typical expiry of raw and blended dry powder materials is 24-48 months.

Once in solution, if left at room temperature, the coating is good for up to 2 weeks in a sealed container. At refrigerated temperatures, the coating is good for up to 1 month in a sealed container. Degradation of products presents itself by bacterial/fungal growth and loss of viscosity. Bacterial/fungal growth can be offset by introduction of low molecular weight alcohols such as ethanol or isopropyl alcohol. Addition of an antimicrobial or biocidal agent is also possible but could potentially be less ideal from a biocompatibility standpoint.

### Effects of Temperature on Coating Formulations

Generally, room temperature tap water is sufficient for complete dissolution of the dry ingredients into solution. Solutions can be heated to temperatures of up to 140° F. (60° C.) to assist with dissolution and lower viscosity.

Under high shear mixing conditions and moderate heat, viscosity of solutions can lower by 20-50% depending on total dissolved solids (TDS) and ingredient ratios (thixotropic, or “shear thinning”). This can be helpful when using application methods that require lower viscosities while maximizing the TDS of the solution.

At temperatures of 140° F. (60° C.) and above, the cellulosic present in the formulation will begin to gel and crash out of solution.

### Drying Time/Temperature

If the one-part coating (e.g., prior to mixing with the calcium) is dried at too high of a temperature, or too quickly, the network will not subsequently form properly, and it will become discolored (e.g., turn white). This is free calcium, which is highly undesirable, as its extremely hygroscopic and can reabsorb moisture and facilitate hydration/degradation of the barrier. Drying should preferably be controlled to the point that water is not flashed off, as that can result in voids/gaps on the surface and a barrier may be compromised accordingly.

The coating is capable of drying at room temperature if given time, however some heat may be applied to ensure the network is fully formed.

Recommended drying temperature ranges from 60-100° C., however this depends on the presence of air convection. With proper air flow, higher temperatures are not required.

### Defoamer

Defoaming agents generally come in the form of hydrocarbon-based and silicon-based defoamers. Silicon-based defoamers are considered less advantageous in that they tend for emulsions, which can increase viscosity. The inventors have experienced success with two main defoaming agents: Advantage 831 and Foam-A-Tac 2-255-37. Advantage 831 defoaming agent is a hydrocarbon-oil based defoamer designed for water-based coatings. Foam-A-Tac 2-255-37 is a soybean oil based defoaming agent designed for water-based inks. Quantities used range from 0.025%-0.1%. The defoamer begins to degrade the coating performance at 0.2%.

Degradation from defoamer presents as a decrease in overall performance (lowered 3M grease kit value, increased OTR etc.). In extreme cases, excess defoaming agents can appear to degrade the coating to the point of visible holes in the coating.

Defoamers work best when added directly to water and dispersed through high shear mixing, prior to the addition of solid ingredients.

### Effects of Low Molecular Weight Alcohols

The present inventors have observed positive results from addition of low molecular weight alcohols such as ethanol and isopropyl alcohol to formulations. These alcohols improve formulations in a number of ways: they act as an antimicrobial agent, increasing the shelf life of the solutions; and when added in quantities of 10-20% prior to addition of dry ingredients, these alcohols are excellent defoaming agents and greatly reduce mixing times by eliminating entrapped air in solutions. These alcohols decrease the surface tension of the formulations, allowing for greater transfer efficiency of the material to the substrate.

### Substrate Pre-Treatment

The substrate must have adequate surface energy (measured in Dynes) to accept an aqueous based coating. In general, the higher the Dyne value, the better for the barrier coating.

For poly/film substrates, the presently disclosed coatings will adhere much better if the film and/or substrate has been surface-energy-enhanced with one of the more common methods available, such as corona discharge treatment or exposure to ozonolysis.

For thinner papers or substrates, it is helpful if one or more of the following is present prior to the application of the compounds of the current disclosure: starch base coat, clay coating, and/or machine glaze. These base coats help to smooth out the surface of the substrate and allow for an even application of the compounds of the current disclosure. These pre-treatments also allow for a lower coat weight of the current disclosure coating to be applied to achieve the desired performance.

When applied to the substrates, coating gives the material OTR, OGR, and release/nonstick properties. The material is compatible with cooking methods such as microwave heating, oven baking, and air frying. Additionally, the material is compatible with freezer and refrigerator storage. The coating performs well without any fluorinated compounds such as PFOS/PFAS, without heavy metals, and is plastic-free according to the EU, US, Japan and other worldwide regulatory bodies.

Further embodiments are illustrated in the following examples, which are described for illustrative purposes only and are not intended to limit the scope of the disclosure.

### EXAMPLES

Having now described various embodiments of the present disclosure, in general, the following examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure. The following examples are described to provide those of ordinary skill in the art with a complete disclosure and description of how to perform the methods and use the probes disclosed and claimed herein. Unless indicated otherwise, parts are parts by weight, temperature is in ° C., and pressure is at or near atmospheric. Standard temperature and pressure are defined as 20° C. and 1.0 atmosphere.

### Examples of Coating Performance

### OGR (Oil and Grease Resistance)

Formulations ranging from 6%-12% total dissolved solids (TDS) were found to be in the optimum performance range for oil and grease resistance. This TDS range is adjustable depending on the application method required. The present inventors have found that a ratio of 2.5:1 HPMC F50 to CaCl₂) provides the optimum combination of viscosity and performance, however, the inventors are able to operate successfully with ratios ranging from 4:1 HPMC F50 to CaCl₂) up to 1:1 HPMC F50 to CaCl₂). Coat weights are highly dependent on the substrate, but generally provide good to excellent oil and grease resistance at dry coat weights between 3-6 gsm with some substrates providing a good grease barrier at less than 2 gsm. Specific examples of the oil and grease resistance capabilities of the disclosed compounds are shown below.

| | | Coat | |
|---|---|---|---|
| | | Weight | |
| Substrate | Formulation | (gsm) | Results |
| 20 pt | 5.5% HPMC F50, 2% | 6.26 | 3M Grease Kit Value of 12 |
| Masterworks | CaCl₂ 0.1% Advantage | | |
| NEWS | 831 | | |
| 21.9 pt Holman | 5.5% HPMC F50, 2 | 7.75 | 3M Grease Kit Value of 12 |
| Inverform | CaCl₂ 0.1% Advantage | | |
| | 831 | | |
| 255 gsm Stora | 5.5% HPMC F50, 2% | 2.84 | 3M Grease Kit Value of 12 |
| Enso CKB | CaCl₂ 0.1% Advantage | | 30-minute peanut oil holdout |
| | 831 | | Passed red shortening test |
| 325 gsm Stora | 5.5% HPMC F50, 2% | 5.44 | 3M Grease Kit Value of 12 |
| Enso CKB | CaCl₂ 0.1% Advantage | | 30-minute peanut oil holdout |
| | 831 | | Passed red shortening test |
| 20# Acadia | 4% HPMC F50, 2% CaCl₂, | 4.37 | Grease Kit Value of 12 |
| NSR | 0.025% Foam-A-Tac | | |
| | 2-255-37 | | |
| 35# Acadia | 4% HPMC F50, 2% CaCl₂, | 6.62 | Grease Kit Value of 12 |
| NSR | 0.025% Foam-A-Tac | | |
| | 2-255-37 | | |
| 18# Catalyst | 5.5% HPMC F50, CaCl₂ | 4.58 | 3M Grease Kit Value of 12 |
| Bistro Wax | 0.1% Advantage 831 | | 30-minute peanut oil holdout |
| | | | Passed red shortening test |
| 20# Catalyst | 5.5% HPMC F50, CaCl₂ | 4.63 | 3M Grease Kit Value of 12 |
| Bistro Wax | 0.1% Advantage 831 | | 30-minute peanut oil holdout |
| | | | Passed red shortening test |
| 20# Catalyst | 4% HPMC F50, 2% CaCl₂, | 4.41 | Grease Kit Value of 12 |
| Bistro Wax | 0.025% Foam-A-Tac | | |
| | 2-255-37 | | |
| 18# Catalysts | 5.5% HPMC F50, 2% | 3.31 | 3M Grease Kit Value of 12 |
| Natural Kraft | CaCl₂, 0.1% Advantage 831 | | 30-minute peanut oil holdout |
| Bistro Wax | | | |
| 30# Pixelle | 5% HPMC F50 5% CaCl₂ | 8.69 | 3M Grease Kit Value of 12 |
| Pointflex | 0.1% Advantage 831 | | |
| 55# Extensible | 5.5% HPMC F50 2% | 6.77 | 3M Grease Kit Value of 12 |
| Kraft | CaCl₂ 0.1% Advantage 831 | | |
| 20# Biorigin | 5.5% HPMC F50 2% | 1.89 | 3M Grease Kit Value of 7 |
| | CaCl₂ 0.1% Advantage 831 | | |
| 20# Biorigin | 5.5% HPMC F50 2% | 3.14 | 3M Grease Kit Value of 9 |
| | CaCl₂ 0.1% Advantage 831 | | |
| 20# Biorigin | 5.5% HPMC F50 2% | 6 | 3M Grease Kit Value of 12 |
| | CaCl₂ 0.1% Advantage 831 | | |

### Heat Seal

Formulations developed for heat-sealability, i.e., the ability of the coated substrate to be melted and adhered with heat/pressure or combination thereof, had the best success at 12% TDS (total dissolved solids). The 2.3:1 ratio between the HPMC E5 and HPMC F5S0 allows for the F50 to stabilize the E5-Calcium network without interfering with the heat-sealability. The amount of calcium included can range from 2-10%. Thicker substrates may require a higher calcium content to aid in heat-sealability. The samples tested for heat sealability (e.g., using a heated bar) have been tested at 200° C. Specific examples are listed below:

| | | Coat | |
|---|---|---|---|
| | | Weight | |
| Substrate | Formulation | (gsm) | Results |
| 120 gsm Sappi | 7% HPMC E5, 3% HPMC | 5.5 | Heat-Sealable |
| AF | F50, 2% CaCl₂, 0.1% | | 3M Grease Kit |
| | Advantage 831 | | Value of 12 |
| 35# GPI | 7% HPMC E5, 3% HPMC | 4.91 | Heat-Sealable |
| Kraft | F50, 2% CaCl₂, 0.1% | | |
| | Advantage 831 | | |

Note that heat seal is generally compatible with lower molecular weights. E5 is very low while F50 is med/high. A mix of a high and low gives the formulation stability while still enabling ability to heat seal. Note that these formulations and values are also generally what is needed to enable extrusion processing, which has also been explored by the present inventors.

### OTR (Oxygen Transmission Rate)

Formulations developed for oxygen resistance require a higher total dissolved solids, between 7-12% TDS. Best results have been achieved at a ratio of 1.4:1 for HPMC F50 to CaCl₂ with coat weights between 5 and 12 gsm. Surface chemistry of the substrate is crucial to the formation of a good oxygen barrier. Additionally, characteristics such as surface roughness and porosity can greatly affect the performance of the oxygen barrier formation. Based on observed performance it can be reasonably expected that OTR values can be obtained with the disclosed compounds that would be competitive with products currently available on the market. These would include paper/molded fiber/containerboard/corrugated and poly. Some specific examples of OTR results with the disclosed compounds are listed below:

| | | Coat | | |
|---|---|---|---|---|
| | | Weight | Oxygen Transmission Rate | |
| Substrate | Formulation | (gsm) | Results | |
| Futamura | 7% HPMC F50, 5% | 10.8 | 4.722 | cc/m²/day |
| PET Film | CaCl₂ | | | |
| Toyobo | 7% HPMC F50, 5% | 7.2 | 4.163 | cc/m²/day |
| PET film | CaCl₂ | | | |
| BOPP | 7% HPMC F50, 5% | 10.8 | 4.263 | cc/m²/day |
| | CaCl₂ | | | |
| 18 pt. | 5.5% HPMC F50, | 6.18 | 15.204 | cc/m²/day |
| Holman | 2% CaCl₂, | | | |
| Inverform | 0.1% Advantage | | | |
| | 831 | | | |

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A method for manufacturing a coated substrate for use in packaging prepared food, comprising the steps of:
providing a liquid coating formulation comprising about 3% to about 6% HPMC and about 1% to about 6% calcium salt;
applying the liquid coating formulation to a food packaging substrate at a coat weight in the rage of about 2 gsm to about 9 gsm to produce a coated substrate;
drying the coated substrate to remove excess water from the coated surface of the substrate to produce a dried coated substrate; and
wrapping the prepared food with the dried coated substrate with the coated side of the coated substrate facing the prepared food.

2. The method of claim 1, wherein the liquid coating formulation further comprises a defoaming agent.

3. The method of claim 2 wherein the defoaming agent is selected from a family of hydrocarbon-based defoamers at a concentration of about 0.1%.

4. The method of claim 2 wherein the liquid coating formulation further comprises in the range of about 10% to about 30% alcohol.

5. The method of claim 4 wherein the alcohol comprises up to about 25 low molecular weight alcohol.

6. The method of claim 5 wherein the calcium salt comprises CaCl₂).

7. The method of claim 6 wherein the liquid coating formulation comprises about 5.5% HPMC and about 2% CaCl₂).

8. The method of claim 7 wherein the liquid coating formulation is applied to the food packaging substrate at a coat weight in the rage of about 6 gsm to about 7 gsm.

9. The method of claim 8 wherein the HPMC comprises a viscosity grade of about F50.

10. The method of claim 9 wherein the liquid coating formulation is applied to the food packaging substrate at a coat weight in the rage of about 6.26 gsm.

11. The method of claim 10 wherein the uncoated food packaging substrate is selected from the group comprising: 20 pt Masterworks NEWS, 21.9 pt Holman Inverform, 255 gsm Stora Enso CKB, 325 gsm Stora Enso CKB, 20 #Acadia NSR, 35 #Acadia NSR, 18 #Catalyst Bistro Wax, 20 #Catalyst BistroWax, 20 #Catalyst BistroWax, 18 #Catalysts Natural Kraft Bistro Wax, 30 #Pixelle Pointflex, 55 #Extensible Kraft, 20 #Biorigin, 20 #Biorigin, and 20 #Biorigin.

12. The method of claim 9, wherein the step of drying comprises allowing the coated substrate to dry at about room temperature for about 2 hours.

13. The method of claim 9, wherein the step of drying comprises allowing the coated substrate to dry in the presence of air convection at a temperature in the range of about 60-100° C.

14. A food packaging material comprising a substrate and a coating formulation upon which the substrate is applied, wherein:
the coating formulation comprises about 4% HPMC, about 2% CaCl₂), and about 0.025% of a soybean based defoamer; and
the substrate comprises one of 20 #Acadia NSR and 35 #Acadia NSR and the coating formulation is applied at a coat weight of about 4 gsm to about 7 gsm.

15. A food packaging material comprising a substrate and a coating formulation upon which the substrate is applied, wherein:
the coating formulation comprises about 7% HPMC ES, about 3% HPMS FSO, and about 2% CaCl₂.

16. The food packaging material of claim 15 wherein the substrate comprises 120 gsm Sappi AF and the coating formulation is applied at a coat weight of about 5 gsm to about 6 gsm.

17. The food packaging material of claim 15 wherein the substrate comprises 35 #GPI Kraft and the coating formulation is applied at a coat weight of about 4 gsm to about 5 gsm.

18. A food packaging material comprising a substrate and a coating formulation upon which the substrate is applied, wherein:
the coating formulation comprises about 7% HPMC FS50 and about 5% CaCl₂);
the substrate comprises one of Futamura PET film, Toyobo PET film, BOPP, and 18 pt. Holman Inverform; and
the coat weight is in the range of about 6-11 gsm.

19. The food packaging material of claim 18, wherein the coat weight is in the range of about 10.8 gsm.

20. The food packaging material of claim 18, wherein the coat weight is in the range of about 6.18 gsm.
